(19) United States
(12) Patent Application Publication
(10) Pub. No.: US 2018/0045525 A1
(43) Pub. Date: Feb. 15, 2018

(54) Systems and Methods for Predicting Vehicle Fuel Consumption

(71) Applicant: Milemind LLC, Apex, NC (US)

(72) Inventors: Rui Araújo, Porto (PT); Rui Esteves Araújo, Porto (PT); Ângela Igreja, Berlin (DE); Ricardo de Castro, Gilching (DE); German Castignani, Thionville (FR); Douglas Dane Baker, Apex, NC (US)

(21) Appl. No.: 15/423,754

(22) Filed: Feb. 3, 2017

Related U.S. Application Data
(60) Provisional application No. 62/373,100, filed on Aug. 10, 2016.

(51) Int. Cl. G01C 21/34; G01C 21/36

(52) U.S. Cl. CPC G01C 21/3469; G01C 21/3484; G01C 21/3492; G01C 21/362; G01C 21/3641; G01C 21/3617

(57) ABSTRACT

A method for predicting fuel consumption for a vehicle may include (1) receiving a starting location and a desired destination; (2) determining a route between the starting location and desired destination; (3) generating a drive cycle for the route, the drive cycle comprising; (a) receiving historical acceleration data for the vehicle, the historical acceleration data comprising one histogram for each of a given type of road; (b) dividing the route into a plurality of discrete segments; (c) determining a predicted average velocity for each discrete segment; (d) simulating a drive cycle step with the historical acceleration data and predicted average velocity for each discrete segment; and (e) creating a velocity and an acceleration profile from the simulated drive cycle for each discrete segment from the route; and (4) predicting a fuel consumption amount based on the velocity and acceleration profiles from the generated drive cycle.

### CROSS-REFERENCE TO RELATED APPLICATIONS

This application claims priority to U.S. Provisional Patent Application No. 62/373,100, filed on Aug. 10, 2016, the complete disclosure of which is incorporated herein by reference in its entirety.

### BACKGROUND OF THE INVENTION

### 1. Field of the Invention

The present invention generally relates to systems and methods for predicting vehicle fuel efficiency.

### 2. Description Of The Related Art

The efficient utilization of energy resources associated with the transportation of people and goods has been of great concern among government agencies, industry and society in general. The volatile costs of fossil fuels, together with environmental problems and atmospheric pollution, has encouraged the development and marketing of energy efficient vehicles, using strategies such as: (i) reducing the rolling resistance of tires, (ii) reducing mass and the aerodynamic drag factor of the vehicle, (iii) increasing the energy efficiency of the vehicle powertrain (engine, transmission, etc.), (iv) the hybridization of the vehicle through the electric propulsion, etc.

### SUMMARY OF THE INVENTION

Systems and methods for predicting fuel consumption for a vehicle are disclosed. In one embodiment, a method for predicting fuel consumption for a vehicle may include (1) receiving a starting location and a desired destination; (2) determining a route between the starting location and desired destination; (3) generating a drive cycle for the route, the drive cycle comprising; (a) receiving historical acceleration data for the vehicle, the historical acceleration data comprising one histogram for each of a given type of road; (b) dividing the route into a plurality of discrete segments; (c) determining a predicted average velocity for each discrete segment; (d) simulating a drive cycle step with the historical acceleration data and predicted average velocity for each discrete segment; and (e) creating a velocity and an acceleration profile from the simulated drive cycle for each discrete segment from the route; and (4) predicting a fuel consumption amount based on the velocity and acceleration profiles from the generated drive cycle.

In one embodiment, fuel consumption may also be predicted for alternate routes based on the starting location and the desired destination, and a preferred route may be selected

In one embodiment, the preferred route may be selected by a user.

In one embodiment, the preferred route may be selected based on predefined criteria, the predefined criteria may include which route has the lowest predicted fuel consumption, travel time differences between possible routes, distance differences between possible routes, or relative cost of tolls between possible routes.

In one embodiment, the fuel consumption prediction may be further based on at least one of a vehicle specific parameter and a driving condition.

In one embodiment, a vehicle identification number may be used to retrieve the vehicle specific parameter from a database. In one embodiment, the method may also include (1) applying a machine-learning algorithm to compare estimated fuel consumption against real-time or historic actual fuel consumption; and (2) applying a correction factor to the fuel consumption prediction.

In one embodiment, the predicted average velocity for each discrete segment may be determined based on one or more of the historical average velocity for the discrete segment, real-time average velocity data for the discrete segment, and a user's historical average velocity for the discrete segment.

In one embodiment, the histograms may be updated in real-time when a speed variation is detected based on acceleration sampling.

In one embodiment, the method is implemented through software on a mobile electronic device.

In one embodiment, the method may also include (1) monitoring, in real-time, fuel consumption for each discrete segment; (2) comparing the real-time fuel consumption with the predicted fuel consumption for each discrete segment; (3) computing a score for each discrete segment based on deviation from the predicted fuel consumption; and (4) updating a final score based on combining the scores for each discrete segment.

In one embodiment, the preferred route may be modified in real-time based on at least the score for one of the discrete segments.

In one embodiment, the final score may be displayed to a user in real-time.

In one embodiment, the method may also include (1) storing the final score in a database of final scores; (2) comparing the final score against the final scores in the database; and (3) creating one or more leaderboard based on the scores in the database.

In one embodiment, the one or more leaderboards may include a ranking of highest to lowest scores of all time, ranking of scores over a predefined time frame, ranking of scores for a predefined route, or ranking scores for a make and model of automobile.

In one embodiment, the leaderboard may be displayed to a user. A system for predicting vehicle fuel consumption may include: (1) one or more processors; (2) memory having instructions stored thereon, which when executed by the one or more processors, cause the processors to perform the following actions: (a) receive a starting location and a desired destination; (b) determine one or more routes between the starting location and desired destination; (c) generate a drive cycle for each route, the drive cycle comprising: (i) receiving historical acceleration data for the vehicle, the historical acceleration data comprising one histogram for each of a given type of road (ii) dividing the route into discrete segments; (iii) determining a predicted average velocity for each discrete segment; (iv) simulating a drive cycle step with the historical acceleration data and predicted average velocity for each discrete segment; (v) creating a velocity and an acceleration profile from the simulated drive cycle steps for each discrete segment from the route; (3) predict a fuel consumption amount based in part on the velocity and acceleration profiles from the generated drive cycle; and (4) select a preferred route from the one or more routes.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for predicting vehicle fuel efficiency according to one embodiment;

FIG. 2 depicts a method for predicting vehicle fuel efficiency according to one embodiment;

FIG. 3 depicts a method for drive cycle generation according to one embodiment;

FIG. 4 depicts an average speed membership function according to one embodiment;

FIG. 5 depicts an idle time membership function according to one embodiment;

FIG. 6 depicts an acceleration energy membership function according to one embodiment;

FIG. 7 depicts membership functions for the output according to one embodiment;

FIG. 8 depicts a method for computing vehicle acceleration distributions for different road types;

FIG. 9 depicts a system for driver cycle detection based on average speed, idle time and energy of acceleration;

FIG. 10 depicts a method for feedback generation;

FIG. 11 illustrates a function for calculating a feedback score; and

FIG. 12 depicts feedback presented to a user based on one embodiment.

### DETAILED DESCRIPTION OF PREFERRED EMBODIMENTS

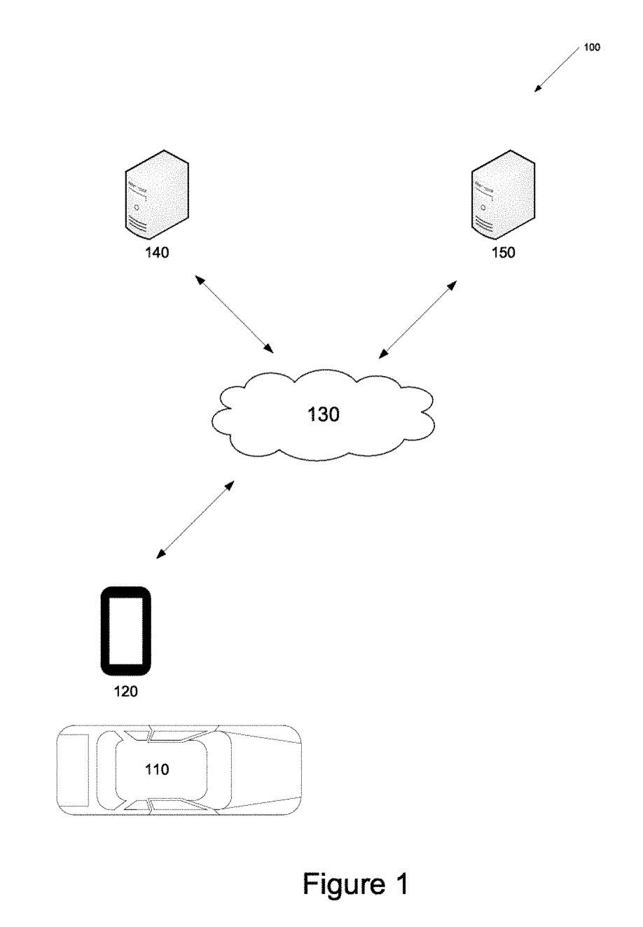

Several embodiments of the present invention and their advantages may be understood by referring to FIGS. 1-12.

Referring to FIG. 1, a system for predicting vehicle fuel consumption is disclosed according to one embodiment. System 100 may include vehicle 110, electronic device 120, one or more network(s) 130, and one or more servers 140 and 150. In one embodiment, electronic device 120 may be a mobile electronic device, such as a smartphone, a tablet computer, a notebook computer, an Internet appliance, etc. In one embodiment, electronic device 120 may be a vehicle-based, or vehicle-embedded electronic device (e.g., a vehicle computer system, a vehicle infotainment system). Any suitable electronic device may be used as necessary.

In one embodiment, electronic device 120 may execute a computer program or computer application (not shown) that may predict fuel consumption for vehicle 110.

In one embodiment, electronic device 120 may communicate with vehicle 110 wirelessly (e.g., NFC, Bluetooth, etc.) or by a physical connection (e.g., via vehicle 110's onboard diagnostic port through a serial, USB or other type of wired connection).

Network(s) 130 may include any suitable communication and/or data network, including WiFi, wired, NFC, cellular, satellite, Internet, combinations thereof, etc. In one embodiment, network(s) 130 may facilitate communications between electronic device 120 and one or more servers 140 and 150.

In one embodiment, servers 140 and 150 may be remotely located from electronic device 120 and may provide data to electronic device 120. For example, servers 140 and 150 may host one or more database that may store vehicle characteristics regarding vehicle 110; Also, servers 140 and 150 may host several API, including a Geographical Routing API to provide route alternatives between origin and destination of vehicle 110. Also, servers 140 and 150 may host a Geographical Map-Matching API that is able to provide contextual information for routes requested by vehicle 110. Such an API may use external services as Here Maps Services or Google Maps Services. Such contextual information may include: road type information, road slope information, road curvature information, live, historical and crowd-sourced traffic information, speed limit information, weather information, etc. It may also indicate road incidents information that may be used by vehicle 110 to decide on changing the current route or re-routing during a trip. In one embodiment, this data may be aggregated. Any information that may have an impact on fuel consumption of a vehicle may be provided as is necessary and/or desired. Also, servers 140 and 150 may host a Vehicle Information API that can provide detailed technical parameters from vehicle 110 that are needed for the calculation of fuel consumption. Such parameters may include, make, model, engine type, mass, air drag coefficient, frontal area of vehicle, etc.

In one embodiment, electronic device 120 may provide data to one or more servers 140 or 150. For example, an electronic device may push traffic data, vehicle data, actual vehicle performance data, fuel consumption data, past experience data, weather data to one or more servers 140 or 150 for processing and aggregation. In one embodiment, one or more servers 140 or 150 may provide some or all of this data to other mobile devices.

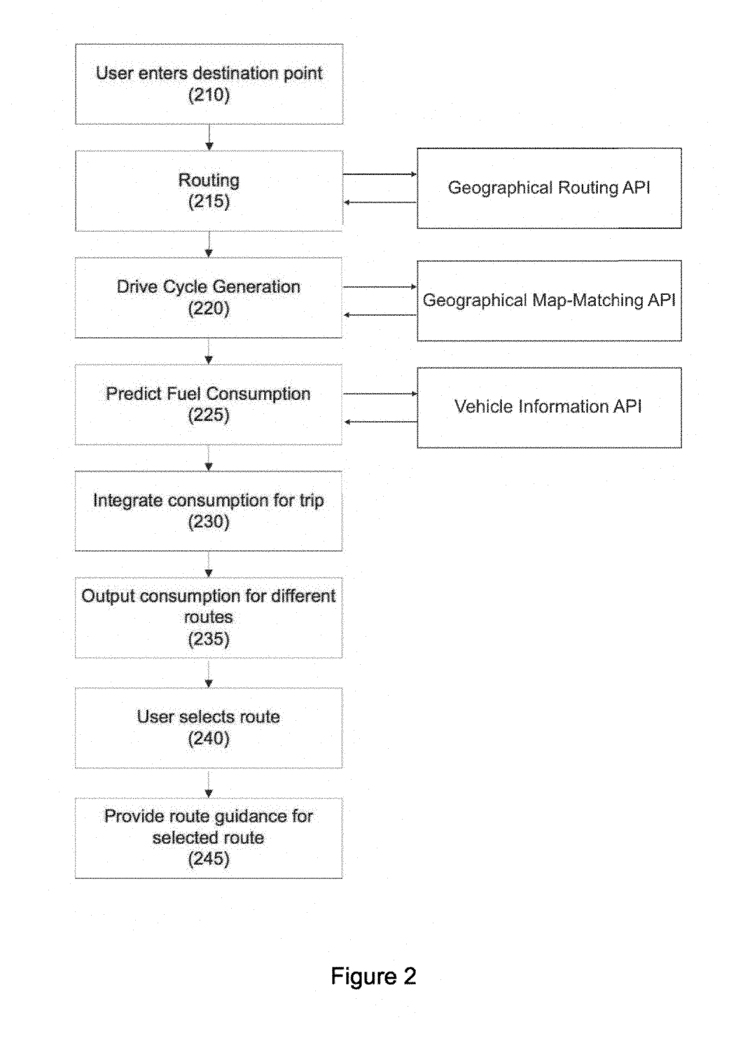

Referring to FIG. 2, a method for predicting vehicle fuel efficiency is disclosed according to one embodiment. In step 210, a user may enter a destination into an application executed by an electronic device 120, such as a smartphone, tablet computer, notebook computer, vehicle-based computer system, etc.

In step 215, the application may request a routing API hosted in servers 140 or 150 to obtain a list of possible routes for a given origin and destination of vehicle 110. For example, Here Maps or Google Maps Services may be used. The application may also request a locally hosted routing API in electronic device 120, like the MKDirections API from Apple, etc. Other routing APIs may be used as necessary and/or desired.

In one embodiment, the routing API may return one or more routes, with each route including a set of instructions. Each instruction may indicate the transition between previous and next road segment that vehicle 110 may take. A road segment may be determined by an origin and a destination coordinate (latitude, longitude) and may belong to one or more road types (highway, motorway, primary network, secondary network, residential area, etc.).

In step 220, the instructions may be provided to a drive cycle generator, which may use a Geographical Map-Matching API hosted in servers 140 or 150. An example of such is the Here Maps Service API (available from Here.com). The Geographical Map-Matching API may provide information that defines historical suitable velocities for each instruction representing a road segment in the route. The historical suitable velocity may be calculated by taking into account legal speed limit, historical traffic or road curvature profile. The historical suitable velocities may also include historical user driving behavior on these road segments, or generally. Also, information about the slope profile of each road segment may be provided by the Geographical Map-Matching API.

In one embodiment, drive cycle generator may return a velocity and acceleration profile for the fuel estimation model. In another embodiment, it may use the suitable velocities retrieved from the Geographical Map-Matching as a setpoint for each road segment to generate a velocity and acceleration profile for the route, for a portion of the route, etc.

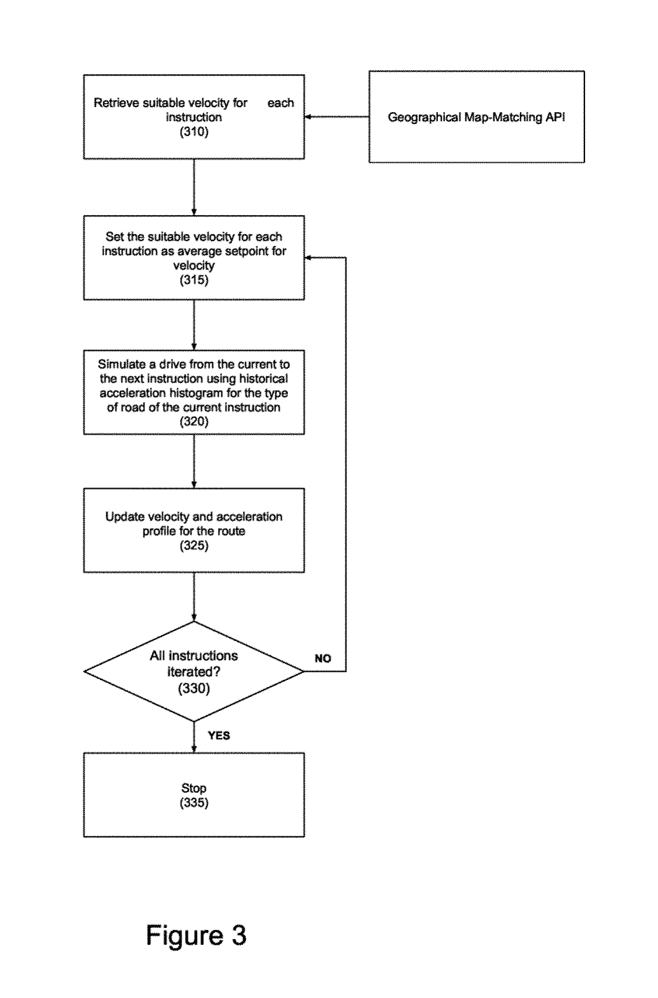

Referring to FIG. 3, an embodiment of drive cycle generation is provided. In one embodiment, two inputs may be provided to the drive cycle generator—the route to evaluate and historical acceleration data. Two outputs—a velocity profile and an acceleration profile—may be calculated.

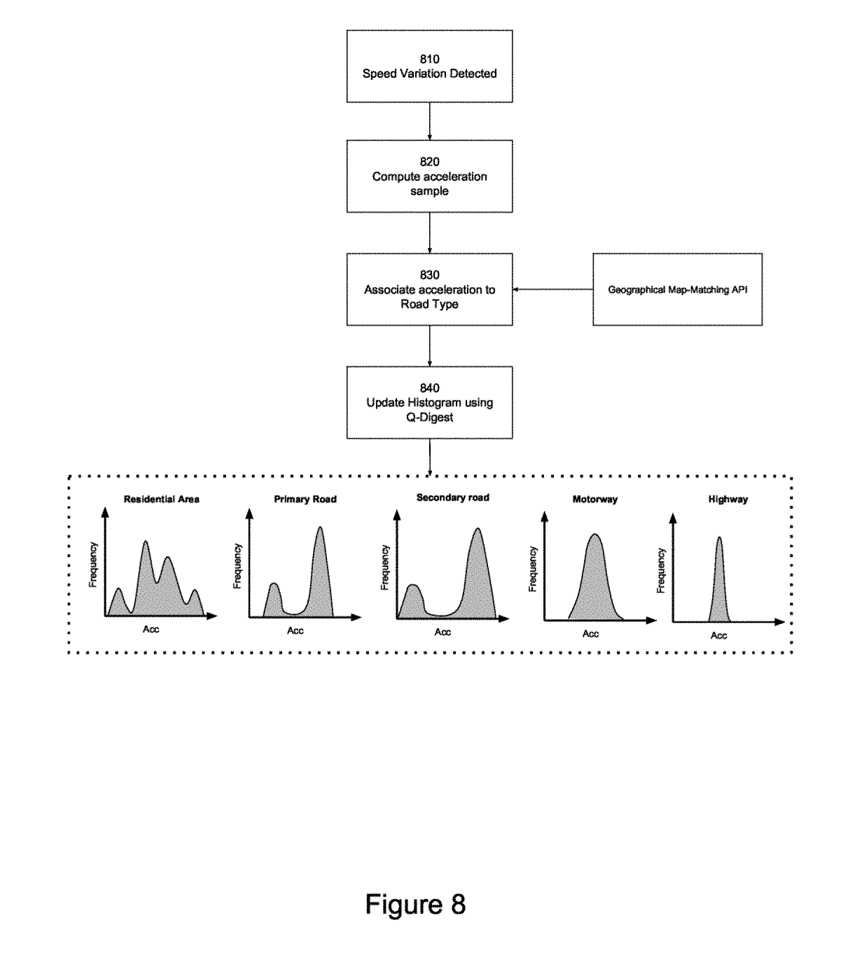

Referring to FIG. 8, the historical acceleration data consists of a set of histograms of historical driver accelerations. This data may be collected from vehicle 110. One histogram per road type may be calculated so as to obtain an accurate representation of the acceleration pattern in each different driving scenario. Road types may be obtained from the Geographical Routing API hosted in servers 140 and 150 when requesting routes in step 215. The histograms calculation may include the following. Vehicle 110 detects a speed variation in step 810. Vehicle 110 computes acceleration sample in step 820 and associates it with the corresponding road type in step 830. A histogram may then be updated for each driving cycle in step 840. Histograms may be computed using the Q-Digest approach, disclosed in Shrivastava et al. “Medians and Beyond: New Aggregation Techniques for Sensor Networks”, ACM SenSys 2004. Q-Digest provides a fast and scalable manner of computing histograms without need of storing all the historical acceleration samples for each driving cycle. Historical acceleration histograms may be stored on electronic device 120 and used locally. Also, these histograms may be sent to servers 140 and 150 for aggregation and update in an API. Then, the request for historical acceleration data in the drive cycle generation process may be requested to this API or directly provided within the route request process in step 215.

In step 310, for each instruction in the route, the Geographical Map-Matching API may provide suitable velocity data for that instruction.

In step 315, the retrieved speed may be set as a setpoint for the velocity of the instruction.

In step 320, a simple driver model may be used to simulate a drive cycle for a step between the current and the next instruction. In one embodiment, historical acceleration data may be randomly selected depending on the difference between the current velocity (e.g., the velocity at the current instruction) and the target velocity (e.g., the velocity at the next instruction). The system may randomly select a positive acceleration value (if target speed is greater than current speed) or a negative acceleration value (if target speed is lower than current speed) from the historical acceleration histogram of the corresponding road type associated to the instruction. In the case current velocity and target velocity are equal, acceleration value may be set to zero. The system may allow deviation from the setpoint velocity, which may be static or dynamic. In one embodiment, the deviation parameter may be set to, for example, to 1 m/s.

In step 325, the current velocity and acceleration may be used to update the velocity and acceleration profile of the route, which may be used as input for the fuel estimation model.

In one embodiment, after updating the route velocity and acceleration profile, the process moves to the next step.

In step 330, it may be determined if all drive cycle instructions have been iterated. If not, the system may move back to step 315 for the next drive cycle instruction. If yes, the system may proceed to step 335. When there are no steps remaining, in step 335, the process stops. The final acceleration profile and velocity profile are returned. These profiles are then used to create a fuel consumption profile, which may be integrated to predict total fuel consumption for the route.

Referring again to FIG. 2, in step 225, a fuel consumption prediction for the route(s) may be predicted based on the velocity and acceleration profile. In one embodiment, vehicle parameters may be considered in the prediction. For example, vehicle parameters, such as vehicle mass, vehicle moving mass, vehicle air drag, vehicle frontal area, vehicle rolling loss, vehicle braking efficiency, equivalent heat fuel, vehicle idle consumption, vehicle maximum consumption, etc., may be considered.

Other parameters that may be considered include driving cycle parameters (e.g., stop and go, urban, semi-urban, motorway without traffic, motorway with traffic, highway with traffic, highway without traffic, etc.).

Any other suitable parameter may be considered as necessary and/or desired. Combinations of parameters may be used as necessary and/or desired.

In one embodiment, one or more of the parameters may be retrieved from a database based on a Vehicle Identification Number (VIN) of vehicle 110. In another embodiment, parameters may be retrieved from the vehicle through, for example, the on-board diagnostics interface or any other suitable vehicle interface. In one embodiment, vehicle parameters can be retrieved through an external Vehicle Information API, hosted in servers 140 or 150. Such a Vehicle Information API may require as input the VIN or any other set of information that allows to identify the vehicle (e.g., make, model, year). The Vehicle Information API returns as output the technical vehicle parameters required by the fuel consumption model.

In one embodiment, machine-learning algorithms may be used to refine the parameters. For example, actual vehicle fuel usage (or any other information) may be received from the vehicle onboard system, and may be compared to the estimated fuel usage by the model. The parameters used by the models may be refined to compensate potential deviations.

In one embodiment, the actual vehicle fuel usage information or other information may be received through wire or wireless connection to the OBD interface, using WiFi, Bluetooth, NFC, Serial, USB or any other wired or wireless technology.

In one embodiment, if a parameter is not available, it may be estimated based on other parameters.

In one embodiment, a suitable fuel estimation model is disclosed in Daniel Macias, “Estimation of Fuel Consumption for Real Time Implementation” Thesis, KTH Electrical Engineering, 2012, the disclosure of which is incorporated, by reference, in its entirety. In particular, we refer to the Real Time (RT) model described in Section 4.3 of the aforementioned reference. Such a model can be used to estimate the fuel consumption of each instruction or step of a route. Equations for the model are as follows:

$${F}_{w} = ( m + {m}_{j} ) a + \frac{1}{2} {c}_{d} A ρ {υ}^{2} + {mgc}_{r} cos ( θ ) + m g sin ( θ )$$

$$fi = f {t}_{idle} + \frac{δ}{η {H}_{0}} ( {F}_{w} υ )$$

$$η = f ( CC )$$

$$δ = \{ \begin{matrix}1 & if & {F}_{w} > 0 \\ 0 & if & {F}_{2} \leq 0\end{matrix} \\ f t = \{ \begin{matrix}{f}_{max} & if & {f}_{i} > {f}_{max} \\ {f}_{i} & if & {f}_{i} \leq {f}_{max}\end{matrix} \\ {F}_{t} = \int f tdt \\ η = \{ \begin{matrix}{η}_{i} + \frac{CC}{1000} & CC = Stop and Go \\ {η}_{i} + \frac{CC}{2000} & CC = Urban \\ {η}_{i} + \frac{CC}{6000} & CC = Semi \text{-} Urban \\ {η}_{i} + \frac{CC}{3000} & CC = Motorway without traffic \\ {η}_{i} + \frac{CC}{8000} & CC = Motorway with traffic \\ {η}_{i} + \frac{CC}{1500} & CC = Highway with traffic \\ {η}_{i} + \frac{CC}{6000} & CC = Highway without traffic\end{matrix}$$

In this model, D_{ω} (in N) fₜ represents the total resistance applied to the vehicle and is used to calculate (in cm³/s), the instantaneous fuel consumption of the vehicle, which is composed of a constant idle consumption time ft_{idle} and a variable consumption, which is function of total resistance F_{ω}, vehicle speed v and drive cycle type CC (which impacts variable efficiency η). The estimation of drive cycle type CC is introduced further in this patent. The total fuel consumption for the route is Fₜ

Table 1 provides the outputs of the model, while Table 2 provides the input of the model (which comes from step 220, drive cycle generation) and the estimation of the drive cycle type. Table 3 provides the parameters of the model, which come from the Vehicle Information API or are well-defined constants.

TABLE 1
Outputs of the final model

| Output | Description | Units |
|---|---|---|
| Fw | Total resistance | N |
| ft | Instantaneous consumption | cm³/s |
| δ | Consumption control when stopped vehicle | — |
| η | Variable efficiency | — |

TABLE 2
Inputs of the final model

| Input | Description | Units | Acquisition | Acquisition option |
|---|---|---|---|---|
| θ | Road slope | rad | Accelerometer | GPS |
| a | Vehicle acceleration | m/s² | Accelerometer | GPS |
| v | Vehicle speed | m/s | Vehicle CAN | GPS/Accelerometer |
| | | | network | |
| CC | Driving Cycle Type | — | Estimation | — |

TABLE 3
Model parameters

| Parameter | Description | Units |
|---|---|---|
| g | Gravitational acceleration | m/s² |
| m | Mass of vehicle | kg |
| mⱼ | Equivalent mass and inertia of the moving parts | kg |
| H_{g} | Heat equivalent of fuel | J/cm³ |
| ft_{idle} | Consumption rate in neutral | cm³/s |
| ρ | Density of air | kg/m³ |
| A | Frontal area of the vehicle | m² |
| C_{d} | Air drag coefficient | — |
| Cᵣ | Rolling loss coefficient | — |
| fₘₐₓ | Maximum consumption | L/s |

In one embodiment, the fuel consumption model considers a variable efficiency η to output the fuel consumption. η may be computed using an algorithm that may distinguish among multiple classes of driving cycles, including, for example, Stop and Go, Urban, Semi-Urban, Motorway and Highway. For Motorway and Highway, there may be additional distinction based on the traffic volume.

In one embodiment, a drive cycle algorithm may be based on one disclosed in R. Araujo, A. Igreja, R. de Castro, and R. E. Araujo, “Driving coach: A smartphone application to evaluate driving efficient patterns”, In Intelligent Vehicles Symposium (IV), 2012 IEEE, pages 1005-1010. The disclosure of this document is incorporated, by reference, in its entirety.

In the algorithm disclosed in Araujo et al., the primary input is the average speed Ũ, allowing the distinction of driving cycles in three classes is used. The instant algorithm, however, considers idle time tᵢ, which is used to distinguish between urban traffic and “Stop and Go” traffic.

To calculate the idle time tᵢ, the vehicle is presumed to be stationary when moving slower than a specific speed, e.g., 5 km/h.

Average speed Ũ and idle time tᵢ may be used to classify the driving cycle into one of five classes using a Fuzzy Inference System. In order to distinguish based on traffic volume, the energy of acceleration Eₐ may be used. An example calculation of energy of acceleration is disclosed in P. Maragos, J. F. Kaiser, and T. F. Quatieri, “On amplitude and frequency demodulation using energy operators”, Signal Processing, IEEE Transactions on, 41(4):1532-1550, 1993. ISSN 1053-587X, the disclosure of which is hereby incorporated by reference in its entirety.

A suitable equation for calculating energy of acceleration is:

Eₐ[n]=a²[n−1]−a[n]*a[n−2]

where Eₐ and represent the energy of acceleration and acceleration itself, respectively. This entry of the Fuzzy Inference System infers that if the energy of acceleration is high, the area is likely a heavy traffic area, since it is necessary to accelerate and decelerate frequently.

In one embodiment, the energy of acceleration of a route can be computed using a moving average filter. An example of usage of such a filter is disclosed in Y. L. Murphey, Park Jungme, Chen Zhihang, M. L. Kuang, M. A. Masrur, and A. M. Phillips, “Intelligent hybrid vehicle power control—part i: Machine learning of optimal vehicle power”, Vehicular Technology, IEEE Transactions on, 61(8):3519-3530, 2012, the disclosure of which is hereby incorporated by reference in its entirety.

For example, a filter having a time scale of 50 seconds may be used. In one embodiment, this filter may be combined with the value in the previous instant to yield a greater perception of the variation. An example equation represents this filter:

$$\overline{x} ( t ) = α x ( t - 1 ) + \frac{1 - α}{N} {\sum }_{i = 0}^{N - 1} x ( t - i )$$

In one embodiment, N=50, and α=0.2. In one embodiment, an output may be defined between 0 and 100, where each interval is assigned a type of cycle.

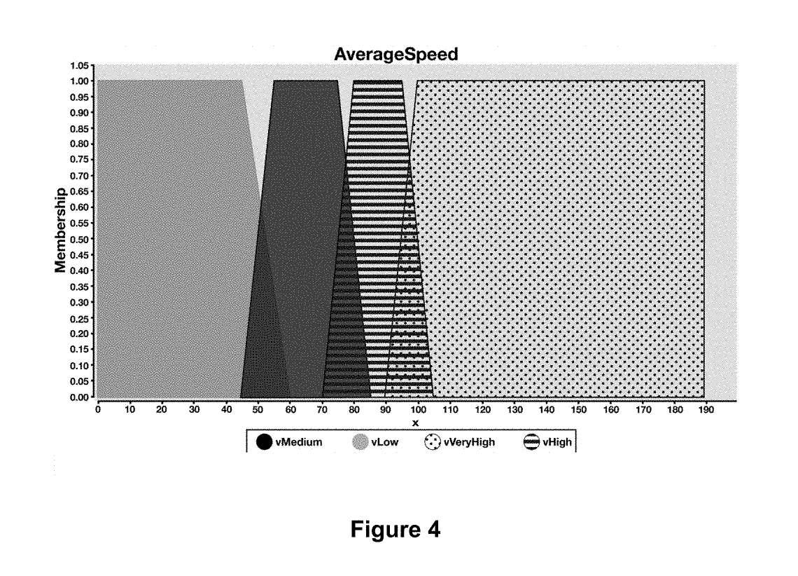

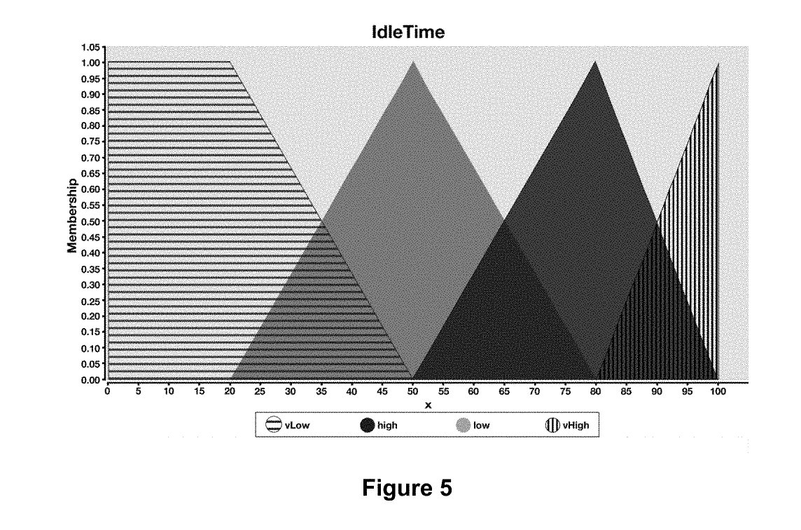

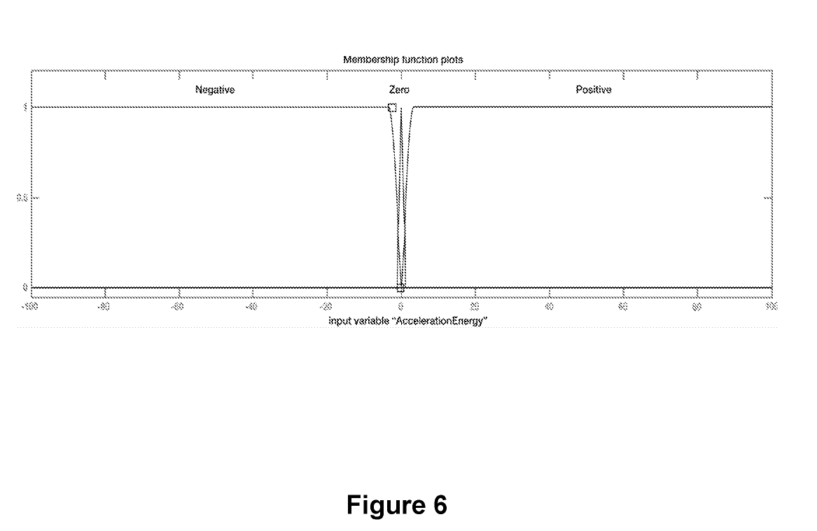

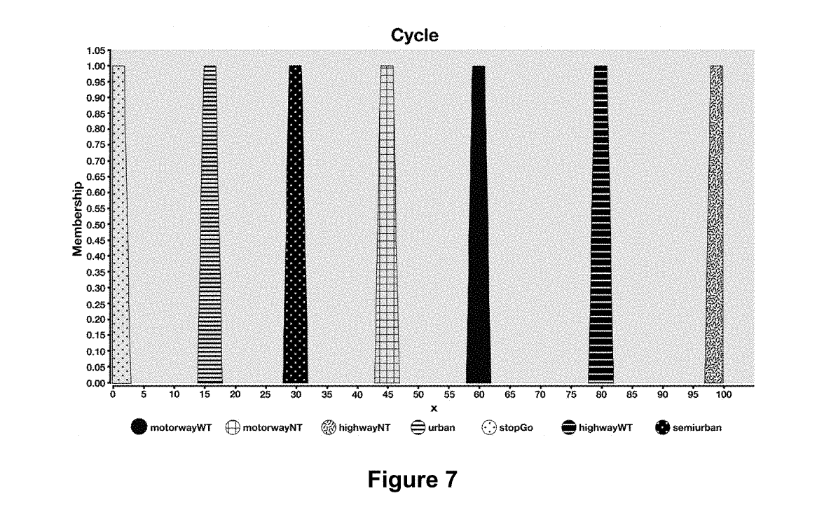

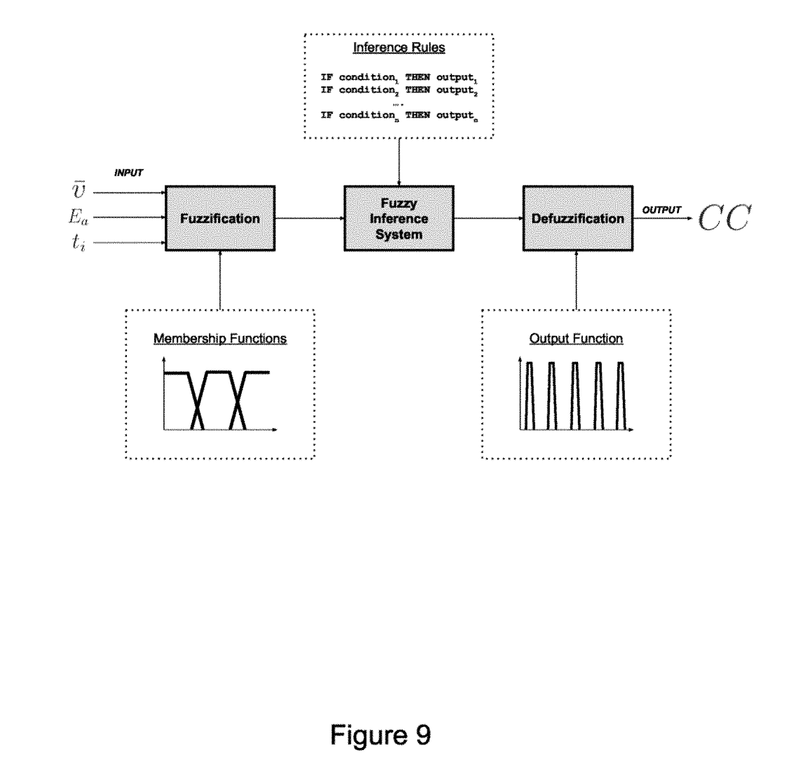

Based on the previously defined inputs (average speed, idle time, and acceleration energy) a Fuzzy System is defined in FIG. 9. The following membership functions are defined. FIG. 4 represents the average speed membership function according to one embodiment, FIG. 5 represents the idle time membership function according to one embodiment; FIG. 6 represents an acceleration energy membership function according to one embodiment, and FIG. 7 represents the membership functions for the output according to one embodiment.

In one embodiment, the membership functions may be set so that the most approximate cycles stay identical. Thus, the output value increases with the increase of the average speed, with cycles with high traffic are also placed consecutively, since they have similar properties.

Based on the membership functions, Tables 4 and 5 provide the Inference Rules that may be used to infer the type of driving cycle.

TABLE 4
Rules using average speed and acceleration

| | | Average Speed | |
|---|---|---|---|
| | | vHigh | vVeryHigh |
| Acceleration | Positive | Motorway with | Highway with |
| Energy | | traffic | traffic |
| | Zero | Motorway without | Highway without |
| | | traffic | traffic |
| | Negative | Motorway with | Highway with |
| | | traffic | traffic |

TABLE 5
Rules using average speed and idle time

Average Speed

| | | vLow | vMedium |
|---|---|---|---|
| Idle time | Low | Urban | Semi-Urban |
| | High | Stop and Go | Semi-Urban |

In one embodiment, weight of rules for vMedium is ½.

In step 230, the fuel consumption profile may be integrated, and may return total fuel consumption estimation for that route, called Fₜ. In one embodiment, if more than one route is available, the process may be repeated for each route.

In step 235, the application may present the different routes, along with the predicted total fuel consumption (Fₜ) for each route, to the user, and, in step 240, the user may select a route.

In another embodiment, the application may automatically select the route with the lowest total fuel consumption (Fₜ) estimation.

In one embodiment, in step 245, the application may provide route guidance for the selected route. In another embodiment, the application may launch a separate navigation application to provide route guidance over a map. In still another embodiment, the application may interface with an on-board vehicle navigation or infotainment system and provide the route to the on-board vehicle navigation system. This interface between the application and on-board system may use existing protocols as Apple CarPlay, Android MirrorLink, Android Auto, etc.

In one embodiment, during the route navigation, the electronic device 120 may provide feedback to the driver regarding his performance in terms of fuel consumption. This feedback focuses on minimizing the deviation of real-time fuel consumption estimation and the predicted fuel consumption computed in step 225. This feedback is sent to the electronic device 120 that can then show it to the driver through a dedicated or external smartphone, tablet or smartwatch application. This feedback may also be provided through an interface to the on-board system.

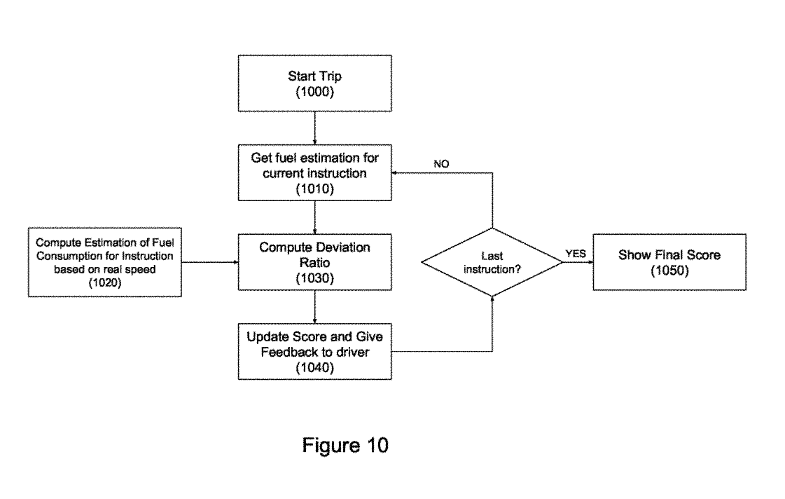

A mechanism for feedback generation is presented in FIG. 10. In step 1000, the driver starts the navigation process. In step 1010, for the current instruction of the navigation, step (i), the system obtains the previously computed prediction of the fuel estimation (pᵢ). At the end of the instruction, in step 1020, based on the real speed profile of the instruction, a new estimation of the fuel consumption is calculated (eᵢ). In step 1030, a deviation ratio for the instruction i (Rᵢ)

Rᵢ=pᵢ/eᵢ

In one embodiment, the ratio R represents the relation between the previously predicted fuel consumption (pᵢ) and the estimated fuel consumption (eᵢ) based on real-speed for the same route instruction i. A ratio R₁ greater than 1 implies that the speed profile taken by the driver generated lower fuel consumption than the originally predicted one in step 225. On the other hand, a ratio between 0 and 1 implies higher fuel consumption than the previously predicted one.

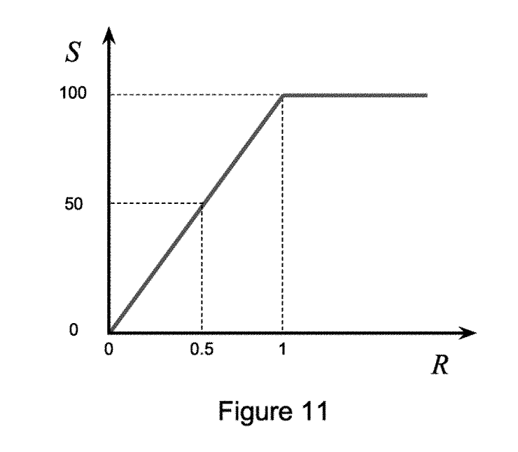

In one embodiment, the feedback provided to the driver is composed of a score between 0 and 100. The score for instruction i (Sᵢ) is calculated using the piece-wise defined function illustrated in FIG. 11.

$${S}_{i} = \{ \begin{matrix}100 \cdot {R}_{i} & if 1 > {R}_{i} > 0 \\ 0 & if {R}_{i} \geq 1\end{matrix}$$

In order to provide feedback to the driver, in step 1040 the score of the trip T at iteration j (S_{T}^{j}) is updated and provided to the driver as a feedback after each iteration. In one embodiment, the score of the trip S_{T}^{j} is calculated as a weighted average over distance. This is to compensate rapid fluctuations in case of trips containing many short distance iterations. The score of the trip S_{T}^{j} is iteratively updated after each instruction. The correspondent score for the instruction (Sᵢ) is weighted using the distance driven on instruction i (dᵢ). The score of the trip is then updated in step 1040 using the following equation, where j is the current instruction:

$${S}_{T}^{j} = {\sum }_{i = 1}^{j} {S}_{i} \cdot {d}_{i}$$

In step 1050, at the end of the trip (when last iteration of the route is achieved), the final score is provided to the driver. This final score, S_{T}ⁿ, is calculated using the equation provided above for the n^{th} (last) iteration of the route.

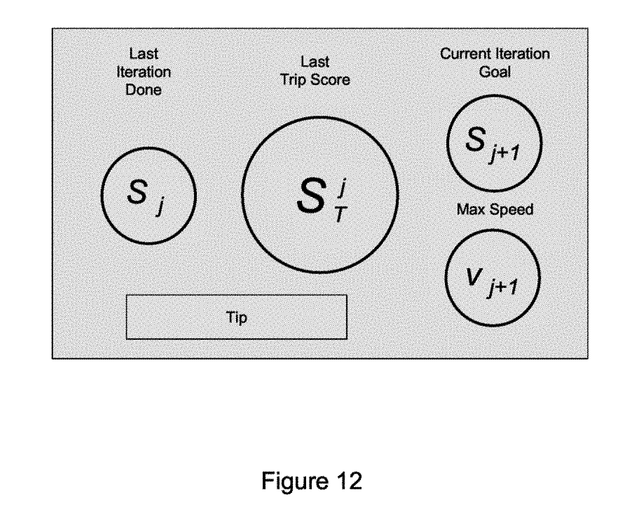

In one embodiment, FIG. 12 illustrates the feedback shown to the driver through electronic device 120 or any of its interfaces (smartphone, smartwatch, tablet, car embedded system). In another embodiment, the system may inform the evolution of the score during a trip. The iteration score obtained in the most recently achieved iteration is shown leftmost side of the interface. In the center, the score of the trip updated up to the most recently achieved iteration is shown. Last, the score of the current iteration (Sⱼ₊₁) is updated every time a new estimation of the fuel consumption (eᵢ) is performed by the system. Also, the system may provide as feedback the maximum velocity for the current iteration in order to assure fuel consumption lower than prediction (pᵢ). The update frequency of this component depends on the feedback experience desired (a minimum value may be 1 second). A tip may then be provided as feedback to the driver to help maximizing the score. Such a tip may consist of written or audio advice about how to adapt speed to reach at least the predicted fuel consumption.

In one embodiment, the system may decide to provide re-routing options to drivers during the ongoing trip. Such a decision may be based on systematic deviation from the predicted fuel consumption due to start-stop behavior caused, for instance, by heavy traffic situations. After each iteration, the system may decide to look for new routing alternatives if S_{T}^{j} is lower than a threshold (for instance 50) and the maximum velocity for each iteration was not exceeded by the driver.

In one embodiment, in order to motivate the driver to optimize his score, gamification may be introduced to the system. At the end of each iteration and/or trip, the electronic device 120 may notify to servers 140 and 150 about the performance, in terms of fuel consumption and score of the driver for the iteration i or for the whole trip, from iteration I to n. The system may aggregate this data by time, location and/or driver. The system may then be able to compare performances of all the community of drivers and generate a leaderboard. This leaderboard may have multiple components. First, it may contain a list of ranked drivers in terms of historical total fuel consumption. Second, it may contain a list of ranked drivers in terms of obtained score for a given trip (from iteration 1 to n) or simply a given iteration. The gamification may consist of showing the user, at the end of each iteration or trip, his or her position in the different ranked lists and the evolution of his performance on time (daily, weekly and monthly basis). The user may then directly compare himself with other users driving the same trips or iterations and compete towards a minimization of the fuel consumption. This information may be accessed by the electronic device 120 through an API to servers 140 and 150.

The disclosure of U.S. patent application Ser. No. 14/529,100 is hereby incorporated, by reference, in its entirety.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UXTM operating system, the Novell Netware™ operating system, the Sun Microsystems Solaris™ operating system, the OS/2 ™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module. The software used might also include modular programming in the form of object-oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for predicting fuel consumption for a vehicle comprising:
receiving a starting location and a desired destination;
determining a route between the starting location and desired destination;
generating a drive cycle for the route, the drive cycle comprising;
receiving historical acceleration data for the vehicle, the historical acceleration data comprising one histogram for each of a given type of road;
dividing the route into a plurality of discrete segments;
determining a predicted average velocity for each discrete segment;
simulating a drive cycle step with the historical acceleration data and predicted average velocity for each discrete segment; and
creating a velocity and an acceleration profile from the simulated drive cycle for each discrete segment from the route; and
predicting a fuel consumption amount based on the velocity and acceleration profiles from the generated drive cycle.

2. The method of claim 1, wherein fuel consumption is also predicted for alternate routes based on the starting location and the desired destination, and a preferred route is selected.

3. The method of claim 2, wherein the preferred route is selected by a user.

4. The method of claim 2, wherein the preferred route is selected based on predefined criteria, the predefined criteria including which route has the lowest predicted fuel consumption, travel time differences between possible routes, distance differences between possible routes, or relative cost of tolls between possible routes.

5. The method of claim 1, wherein the fuel consumption prediction is further based on at least one of a vehicle specific parameter and a driving condition.

6. The method of claim 5, wherein a vehicle identification number is used to retrieve the vehicle specific parameter from a database.

7. The method of claim 1, further comprising:
applying a machine-learning algorithm to compare estimated fuel consumption against real-time or historic actual fuel consumption; and
applying a correction factor to the fuel consumption prediction.

8. The method of claim 1, wherein the predicted average velocity for each discrete segment is determined based on one or more of the historical average velocity for the discrete segment, real-time average velocity data for the discrete segment, and a user's historical average velocity for the discrete segment.

9. The method of claim 1, further comprising updating the histograms in real-time when a speed variation is detected based on acceleration sampling.

10. The method of claim 2, further comprising:
monitoring, in real-time, fuel consumption for each discrete segment;
comparing the real-time fuel consumption with the predicted fuel consumption for each discrete segment;
computing a score for each discrete segment based on deviation from the predicted fuel consumption; and
updating a final score based on combining the scores for each discrete segment.

11. The method of claim 10, wherein the preferred route is modified in real-time based on at least the score for one of the discrete segments.

12. The method of claim 10, wherein the final score is displayed to a user in real-time.

13. The method of claim 10, further comprising:
storing the final score in a database of final scores;
comparing the final score against the final scores in the database;
creating one or more leaderboard based on the scores in the database.

14. The method of claim 14, wherein the one or more leaderboards include a ranking of highest to lowest scores of all time, ranking of scores over a predefined time frame, ranking of scores for a predefined route, or ranking scores for a make and model of automobile.

15. The method of claim 15, wherein the leaderboard is displayed to a user.

16. A system for predicting fuel consumption for a vehicle, the system comprising:
one or more processors,
memory having instructions stored thereon, which when executed by the one or more processors, cause the processors to perform the following actions:
receive a starting location and a desired destination;
determine one or more routes between the starting location and desired destination;
generate a drive cycle for each route, the drive cycle comprising;
receiving historical acceleration data for the vehicle, the historical acceleration data comprising one histogram for each of a given type of road;
dividing the route into a plurality of discrete segments;
determining a predicted average velocity for each discrete segment;
simulating a drive cycle step with the historical acceleration data and predicted average velocity for each discrete segment; and
creating a velocity and an acceleration profile from the simulated drive cycle for each discrete segment from the route;
predict a fuel consumption amount based on the velocity and acceleration profiles from the generated drive cycle; and
select a preferred route from the one or more routes.

17. The method of claim 1, wherein the method is implemented through software on a mobile electronic device.
